(19) United States
(12) Patent Application Publication
(10) Pub. No.: US 2010/0133054 A1
(43) Pub. Date: Jun. 3, 2010

(54) Disk Brake Comprising Brake Disk Rings Made of Brittle Material and Vehicle Fitted With One or Several Disk Brakes of Said Type

(76) Inventor: Arnold Wagner, Winterhur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/990,096

(22) PCT Filed: Aug. 8, 2006
(86) PCT No.: PCT/CH2006/000413

§ 371 Date: Feb. 9, 2010

(30) Foreign Application Priority Data
Aug. 8, 2005 (CH) 1304/05

(51) Int. Cl. F16D 65/12

(52) U.S. Cl. 188/218 XL

(57) ABSTRACT

The invention relates to a disk brake (1) which comprises a brake disk ring (2) which is made of brittle material. Said brake comprises, in said ring, receiving holes (18) for lowering rivets (3) and a particular shaping about said holes (19). Said brake also comprises an inner rim (4) which is made of high-grade steel or other similar material, which is riveted to the brake disk ring (2), and which is elastic and comprises star-shaped flat spokes (20), and an intermediate ring (6) which is made of a light metal or similar material which is riveted or screwed to said rim. Said ring can be machined, for the purpose of lag-freedom, parallel to the disk ring surface (13) and adapted to the connection by screwing or riveting (7).

The invention relates to a disc brake with disc brake ring of brittle material of low tensile strength and small breaking elongation, for example of ceramic material and the support device suitable for this purpose. For the sake of weight, brake disc rings are predominantly fastened to the wheel rim or rotational axis with lightweight support devices. Such support devices, mainly of light metal and with floating bearing if applicable, are more preferably generally used in motorcycle construction. Brake disc ring material is mostly heavy cast iron or stainless steel.

In recent times, brake disc material of light, siliconized carbon fibre composite material, which is ceramisized by means of heating, has become available and is already used in railway and automobile construction. In motorcycle construction application problems arose since the tensile strength and the breaking elongation can only amount to 20-30 N/mm² and only 0.1-0.2% respectively and the heat expansion coefficient is practically zero or even negative. Utilizing the possible thermal load up to approximately 1400° C. poses insulation, strength and heat expansion problems with support devices of light metal. The pressure that occurs with the usual floating bearing in the semi-circular force transmission surfaces of the brake disc ring which are open towards the inside results in the tensile strength in the disc material being exceeded and said material even fractured in the event of major braking forces. Radially moveable steel screw connections as connection of the brake disc ring to the support device are also known, but which because of the radial runout which is unavoidable in the process result in balancing problems and irregular braking.

The object of the invention is to create a disc brake with support device which allows the use of light-weight ceramic material with full utilization of the advantages of high thermal load capacity, low abrasion and high friction values as brake disc ring more preferably also in motor cycles without the risk of fracture and can be manufactured cost-effectively.

According to the invention this object is solved in that the brake disc ring on the radial inner side comprises 5-12 receiving holes with counterbores for countersunk rivets of stainless steel or similar material on the disc outer side facing away from the wheel and that the disc material enclosing these holes on the inside is formed with a constant cross sectional area and without constrictions.

A star-shaped inner rim of stainless steel or similar material, each having two flat spokes which run to the receiving hole at a preferably flat angle relative to each other and, at a juncture, comprise a counter hole which fits to the receiving hole, is on the inner side adapted to the rim with a ring and can be riveted onto the ceramic brake disc ring by means of countersunk rivets of stainless steel or similar material and slow wobble or rosette riveting in such a manner that the head of each rivet is merely expanded in the inner rim and no breaking of the ceramic disc ring through expansion in the disc material occurs.

It is particularly practical to adapt the countersunk rivets to the counterbore in the brake disc ring in such a manner that they protrude over the disc surface by a small amount, e.g. approximately 0.5 mm, and pressure is thus only exerted on the disc material through the holding-down and not through riveting blows.

With this riveting at the flat spoke juncture low support areas of the inner rim as well as large hole areas radially on the inside can be achieved. When the disc is hot, only a small rim region about the rivets is heated up, while the spokes heat up very little through air cooling of the hole areas and thus little heat expansion occurs which in addition, because of the flat spoke angle, hardly exerts any bursting effect radially on the brake disc ring through the different heat expansion coefficients of stainless steel or similar material and ceramic. In addition, flat spokes with adapted dimensioning can give way laterally or axially and further reduce the heat stresses as a result.

Since ceramic brake discs more preferably combined with ceramic brake pads have approximately 2-3 times higher friction values compared with steel discs with conventional brake linings, even minor lateral runout of these ceramic brake discs results in brake chatter and/or pulsating braking force. It is therefore indispensable in the construction of the inner rim to provide a certain axial resilience. Axial resilience additionally prevents bending loads of the brake disc ring which on clamping the brake callipers result in fracture because of the low tensile strength. With the disc diameter of 320 mm which is usual for motorcycles with approximately 8 mm brake disc ring thickness and 2 mm rim thickness This resilience is achieved through the thickness ratio between brake disc ring and inner rim, i.e. practically with approximately 8 mm brake disc ring thickness and 2 mm rim thickness for a disc diameter of 320 mm which is usual for motorcycles.

It is additionally advantageous to install an intermediate ring of light metal or similar material between the wheel rim and the inner rim. Practically this intermediate ring is riveted to the inner rim and, after completion of the disc brake consisting of ceramic brake disc ring and the riveted support device consisting of inner rim and intermediate ring, can be adapted free of lateral runout on the support surface against the wheel rim through milling over.

Exemplary embodiments of the invention are shown in the drawings and are described in more detail with reference to these. It shows:

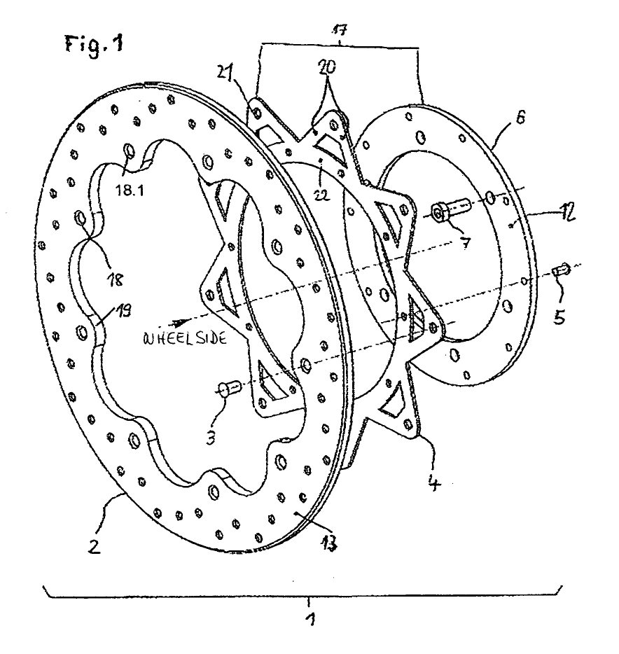

FIG. 1 a perspective exploded drawing of a disc brake 1 according to the invention, consisting of the brake disc ring 2 of brittle material, a countersunk rivet 3, the inner rim 4 of stainless steel or similar material, a round-head rivet 5 and the intermediate ring 6 of light metal or similar material that can be milled over with the receiving holes for the screw connection 7 on the rim of the wheel rim;

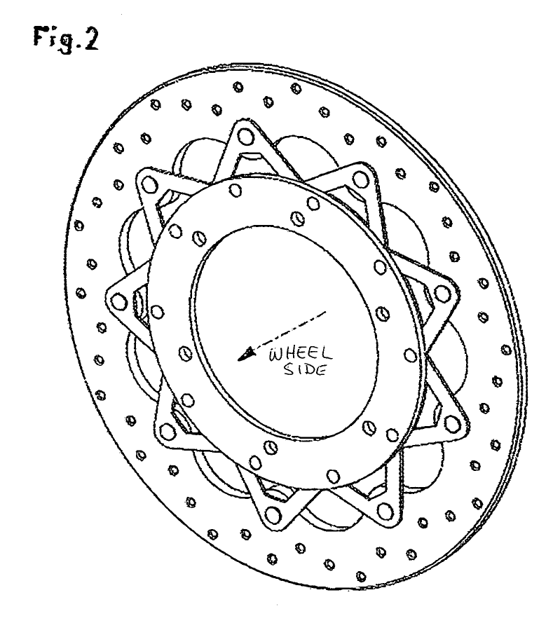

FIG. 2 a perspective representation of the disc brake 1 according to the invention in the state ready for operation;

FIG. 3 a vehicle with two disc brakes 8, 9 according to the invention.

With regard to the FIGS. 1-3 the following embodiments of the invention are described.

The inner rim 4 is slowly, i.e. with riveting frequencies of approximately 20-50 Hz and riveting times of up to approximately 6 seconds, riveted with the countersunk rivets 3 onto the ceramic brake disc ring 2 on the rim side by means of wobble or rosette riveting so that rivet expansion merely occurs in the inner rim 4 and the brittle ceramic material is not burst open. After this, the intermediate ring 6 adapted to the receiving contour of the wheel is positioned on the wheel inside and riveted to the inner rim 4 on the rim side. The contact surface 12 of the intermediate ring 4 with respect to the receiving contour of the wheel is now milled over exactly parallel to the outside 13 of the ceramic brake disc 2 so that no axial runout with regard to the brake calliper during rotation is present. The disc brake 1 can be fastened to the wheel through the screw connections 7.

The vehicle 14 with two disc brakes 8, 9, as shown a cabin motorcycle, has a steerable front wheel 15 with a disc brake 8 and a rear wheel 16 with a second disc brake 9, likewise a body 10 and a support device 11 with support rollers that can be pulled up when riding.

1-6. (canceled)

7. A disc brake (1) for a wheel, characterized in that a support device (17), consisting of an inner rim (4) of stainless steel with an intermediate ring (6) of light metal riveted or screwed thereon is flush-riveted together with a brake disc ring (2) of brittle material, for example ceramic, wherein the brake disc ring (2) on the radial inner side has receiving holes (18) with counterbores (18.1) for countersunk rivets (3) of stainless steel on the disc outer side facing away from the wheel and that the disc material enclosing these holes (18) on the inside is formed with a constant cross section and without constrictions.

8. The disc brake (1) according to claim 1, wherein for riveting inner rim (4) to brake disc ring (2) countersunk rivets (3) of stainless steel are used which slightly protrude at the counterbore (18.1), i.e. approximately 0.5 mm over the brake disc ring (2).

9. The disc brake (1) according to claim 1, wherein the inner rim (4) of stainless steel comprises two star-shaped flat spokes (20) at a preferably flat angle with respect to each other towards each receiving hole (18), which at the juncture have a counter hole (21) fitting the receiving hole and on the hub side merge with a ring (22) adapted to the wheel rim,
and the material thickness of this inner rim (4) is selected so that a resilience of the flat spokes (20) in lateral or axial direction is guaranteed.

10. The disc brake (1) according to claim 1, wherein the intermediate ring (6) riveted or screwed to the inner rim (4) can be re-machined on a side (12) parallel to the brake disc ring surface (13),
to achieve adaptation without runout including screw connection (7) to a rim of a wheel.

11. A vehicle (14) comprising at least one disc brake (8, 9) in accordance with claim 1.
